(19) United States
(12) Patent Application Publication
(10) Pub. No.: US 2025/0053063 A1
(43) Pub. Date: Feb. 13, 2025

(54) RECURRENT QUANTUM PHOTONIC PROCESSOR AND METHODS

(71) Applicant: Ohio State Innovation Foundation, Columbus, OH (US)

(72) Inventors: Mihai Crisan, Columbus, OH (US); Shamsul Arafin, Columbus, OH (US)

(21) Appl. No.: 18/800,711

(22) Filed: Aug. 12, 2024

Related U.S. Application Data
(60) Provisional application No. 63/519,008, filed on Aug. 11, 2023.

(51) Int. Cl. G02F 1/35; G06N 10/40

(52) U.S. Cl. CPC G02F 1/3536; G06N 10/40

(57) ABSTRACT

An exemplary recurrent quantum photonic processor and method are disclosed that can generate squeezed photon states in preparing coherent photonic qubits and then process them through recurrent linear-optic circuitries. The quantum photonic processor can employ vectors of lights and combine them using optical quantum effects for matrix-vector multiplication. The processor includes a plurality of optical circuits, each includes a microring resonator that utilizes spontaneous wave mixing to generate photon number states having an uncertainty smaller than that of a coherent state for qubits. The circuits include a waveguide coupled to the microring resonator, the waveguide having a set phase shifters to cause a phase shift in the optical circuits.

### RELATED APPLICATION

This U.S. application claims priority to, and the benefit of, U.S. Provisional Patent Application No. 63/519,008, filed Aug. 11, 2023, entitled “RECURRENT QUANTUM PHOTONIC PROCESSOR AND METHODS,” which is incorporated by reference herein in its entirety.

### BACKGROUND

Optical computing or photonic computing uses light waves produced by lasers or incoherent sources for data processing, data storage, or data communication for computing. Photons have shown promise to enable a higher bandwidth than the electrons used in conventional computers.

With increasing demands on graphical processing unit-based accelerator technologies, in the second decade of the 21st century, there has been a huge emphasis on the use of on-chip integrated optics to create photonics-based processors. The emergence of both deep learning neural networks based on phase modulation and, more recently, amplitude modulation using photonic memories have created a new area of photonic technologies for neuromorphic computing, leading to new photonic computing technologies, all on a chip such as the photonic tensor core.

There is a benefit to improving the processor technology using photonics.

### SUMMARY

An exemplary recurrent quantum photonic processor and method are disclosed that can generate squeezed photon states in preparing coherent photonic qubits and then process them through recurrent linear-optic circuitries. The quantum photonic processor can employ vectors of lights and combine them using quantum optical effects—spontaneous four-wave mixing—that can be used to provide corresponding outputs to matrix-vector multiplication. The quantum photonic processor can readily determine a matrix-vector operation that can augment or replace float-based digital analogs in the host CPU.

The operation is freely scalable for any number of vector size and matrix. The exemplary quantum photonic processor may employ error-correct operation, e.g., via a programmable linear-optic logic, on the quantum chip.

In some embodiments, the quantum photonic processor can be employed to augment matrix-heavy algorithms as a processor (e.g., a central processor unit (CPU)), co-processor, processor core, graphic processor unit (GPU), processor module, or GPU module.

The exemplary quantum photonic processor (QPP) can exponentially reduce the computational complexity of performing matrix operations. The exemplary system and method can employ the exponentially large Hilbert spaces that are generated through light-speed tensor computations. Photons possess two distinctive advantages over electrons within semiconductors: they have inherent annealability at room temperature, and they have strong-phase stability over long distances (0.3 dB of loss per cm).

In some embodiments, matrix-vector products can be performed having a complexity in the linear O(N) regime with matrix size that previously had a complexity of O(N^{2.37}). The exemplary system and method can thus perform and/or transform what would otherwise be a computationally intractable problem in microelectronics to one that is realizable and efficient within the photonics domain. While current universal optical hardware can scale at O(N²) optical components, the proposed architecture can enjoy an exponential decrease in hardware complexity, which can scale at O(N). This can further compactify universal linear optics by truncating redundant optical layers that can be programmed in the next layer of recursion. Due to this, the hardware architecture can provide greater robustness towards hardware imperfections, allowing for freely scalable photonic processors. Large-scale quantum circuits would no longer be limited by their physical size but rather by how quickly the quantum information (i.e., the photon) degrades over distance on-chip.

Another industry and research application of quantum photonic processor is in modeling complex dynamical systems through random walks (RWs). RWs are processes wherein each walker is allowed to evolve over a set of discrete or continuous states. In essence, the walkers are driven by stochastic processes that directly influence the next transition state of each individual—leading to probability distributions. Here of interest are quantum walks (QWs), whereby QPP can randomly evolve the complex dynamics of each walker's (photon) state efficiently over time. QWs exhibit greater sensitivity towards the QW lattice (i.e., QPP) when compared to their classical counterpart. RWs. As many natural processes are well modeled by QWs, they remain of interest in simulating the interaction between “closed” quantum systems and their environments. Such non-classical walks can be experimentally realized on QPP by exchanging and interfering bosons (e.g., photons) between waveguides for quantum information processing and simulation of processes with exponentially increasing complexities. Such systems can include molecules and protein folding. Molecular modeling on QPP can be constructed by translating the interaction Hamiltonians into the corresponding unitary matrix of the system, which then corresponds to a set of discrete phase shifts on the quantum photonic processor, transforming intangible computational problems to be computationally tractable. Quantum photonic processor can also have applications in combinatorics, quantum chemistry, sampling problems, solid-state physics, and molecular modeling.

Classical deep reinforcement learning (RL) is another natural setting where the quantum photonic processor can accelerate training. In RL, photons can act as carriers of information, either for representing stochastic processes or as input state vectors. The immense practicability of neural networks arises from their ability to generalize on a myriad of tasks. Here, for example, if training a neural network to perform cancer diagnoses from CAT scans, then the input vector may represent a list of grayscale values (pixels) of a CAT scan image. In modern classical machine learning, such algorithms rely immensely on linear algebraic computations, whereby the output vector is directly related to the input vector by a set of matrix-vector products. As mentioned before, quantum photonic processors are capable of accelerating matrix multiplication by arbitrary unitary transformations, thus making quantum photonic processors a time- and energy-efficient computing platform. Alongside the process of raw matrix-vector-multiplications in ANN training, nonlinear operations are also essential in tuning the parameters during ANN training. QPP can actively control and refine the nonlinear activation function, depending on the ANN being trained. The recent developments of ANNs have also increasingly relied on more frequent memory access and larger input vector sizes. As ANNs continue to gain more parameters to be fitted in training, classical microelectronics will fail to keep up with the equivalent demand in upgrading computational power. Here, QPP provides the ability to maintain the stringent requirements in ANN growth and training. With the proposed device, the need for localized volatile memory (e.g., cache, RAM) can be eliminated as information encoded in a vector consisting of coherent optical modes is processed in a feedforward manner. The application of nanophotonics towards matrix information processing has the potential to realize light-based processors that can push past the current physical limitations in microelectronics, all the while decreasing energy consumption. This work is a step forward toward realizing freely scalable QPPs.

In an aspect, a quantum photonic processor (e.g., recurrent quantum photonic processor) is disclosed comprising: a plurality of optical circuits, including a first optical circuit and a second optical circuit, wherein the first optical circuit and the second optical circuit each includes: a first microring resonator (e.g., silicon nitride microring resonators) that utilizes spontaneous wave mixing (e.g., spontaneous four-wave mixing (SFWM)) to generate photon number states having an uncertainty smaller than that of a coherent state for qubits (i.e., having squeezed photons states); a waveguide (e.g., silicon transport waveguide) point coupled to the first microring resonator; a set of one or more phase shifters each comprising (i) a set of one or more tunable beamsplitters formed in part of waveguide and (ii) a set of one or more digitally actuatable phase shifters coupled to a portion the waveguide; and a controller circuit coupled to the set of one or more of digitally actuatable phase shifters of the first optical circuit and a second optical circuit, wherein adjustment by the one or more digitally actuatable phase shifters cause a phase shift in the respective first optical circuit and a second optical circuit.

In some embodiments, the first optical circuit is proximally located to the second optical circuit, wherein the controller circuit is configured to actuate the digitally actuatable phase shifters of the first optical circuit and a second optical circuit according to a matrix operation.

In some embodiments, each microring resonator of the first optical circuit and a second optical circuit is tunable, the each microring resonator includes at least one digitally actuatable phase shifter, wherein adjustment by the one or more digitally actuatable phase shifter element of the each microring resonator tune the wavelength resonance of the each microring resonator.

In some embodiments, each microring resonator of the first optical circuit and a second optical circuit is tunable, the each microring resonator includes at least one digitally actuatable electro-optic element, wherein adjustment by the one or more digitally actuatable electro-optic of the each microring resonator tune the wavelength resonance of the each microring resonator.

In some embodiments, each microring resonator of the first optical circuit and a second optical circuit is tunable, the each microring resonator includes at least one digitally actuatable silicon optical modulator, wherein adjustment by the one or more digitally actuatable silicon optical modulator of the each microring resonator tune the wavelength resonance of the each microring resonator.

In some embodiments, the plurality of optical circuits are arranged in an array of recurrent first optical circuits and second optical circuits (e.g., the array corresponding to the matrix operation, e.g., a matrix-vector multiplier).

In some embodiments, the first microring resonator of the first optical circuit and a second optical circuit are configured to exhibit spontaneous four-wave mixing (SFWM).

In some embodiments, each microring resonator of the first optical circuit and a second optical circuit is tunable; each microring resonator includes at least one digitally actuatable phase shifters, wherein adjustment by the digitally actuatable phase shifters of the microring resonator tunes the wavelength resonance of the microring resonator.

In some embodiments, each microring resonator of the first optical circuit and the second optical circuit is coupled to an optical source (e.g., laser coupled to a controllable splitter).

In some embodiments, the quantum photonic processor further includes a mesh of photonic interferometers (e.g., Mach-Zehnder interferometer (MZIs)) each comprising of (i) a set of tunable phase shifters actuatable microheaters and (ii) integrated optical 50:50 beamsplitters formed by waveguides that are capable of selecting any unitary matrix of dimension 2.

In some embodiments, the quantum photonic processor further includes a mesh of photonic MZIs that are in between two layers of MZIs that are linked back to themselves and enable optical recursion.

In some embodiments, the quantum photonic processor further includes a balanced set of single-photon detectors for optical readout of the single photon states to provide a reduction and removal of classical noise during single photon detection (i.e., reducing detection noise below the standard quantum limit).

In some embodiments, the quantum photonic processor further includes a mesh of photonic interferometers (e.g., Mach-Zehnder interferometer (MZIs)) each comprising of (i) a set of tunable phase shifters and (ii) integrated optical 50:50 beamsplitters (e.g., directional couplers) formed by waveguides that allow for selecting any unitary matrix of dimension 2; a mesh of photonic MZIs that are in between two layers of MZIs that are linked back to themselves that enable optical recursion; and a balanced set of single-photon detectors for optical readout of the single photon states to provide a reduction and removal of classical noise during single photon detector (i.e., reducing detection noise below the standard quantum limit).

In some embodiments, the optical source is coupled to the controller circuit that is configured to amplitude modulate or frequency modulate the optical source.

In some embodiments, the first optical circuit and second optical circuit each further include a detector comprising a second microring resonator (e.g., also configured for spontaneous four-wave mixing (SFWM)).

In some embodiments, each first microring resonator of the first optical circuit and the second optical circuit is formed on an insulator to form a silicon-on-insulator structure (e.g., via epitaxial growth).

In some embodiments, each set of one or more digitally actuatable phase shifters of the first optical circuit and the second optical circuit is formed over the portion of the waveguide of the first optical circuit and second optical circuit.

In some embodiments, the first microring resonator of the first optical circuit and the second optical circuit is a silicon nitride microring resonator.

In some embodiments, each waveguide of the first optical circuit and the second optical circuit is formed of silicon transport waveguides.

In some embodiments, each first microring resonator of the first optical circuit and second optical circuit includes a spectrally selective photonic component (e.g., microring resonator) (e.g., to spectrally filter out low-energy photons (ωᵢ) generated in a photon pair comprising the low-energy idler photons (ωᵢ) and low-energy signal photons (ωₛ) and to filter out the high-energy pump photons (ωₚ)).

In some embodiments, each first microring resonator of the first optical circuit and the second optical circuit is configured as a whispering-gallery-mode resonator.

In some embodiments, each set of one or more tunable beamsplitters of the first optical circuit and the second optical circuit is an array of Mach-Zehnder interferometers (MZIs) comprising a plurality of phase shifters.

In some embodiments, the detector comprises a balanced homodyne detector (e.g., wherein the balanced homodyne detector includes a beamsplitter coupled to at least one photodiode for at least one waveguide of the beamsplitter).

In some embodiments, the quantum photonic processor further includes a second plurality of optical circuits having the first optical circuit and the second optical circuit, wherein the second plurality of optical circuits is configured to perform a second matrix-vector operator.

In some embodiments, the plurality of optical circuits are optically connected to the second plurality of optical circuits (e.g., to provide cascading operations of the matrix operation and the second matrix-vector operator).

In another aspect, a method is disclosed of performing a matrix-vector operation using any of the disclosed plurality of optical circuits, wherein the matrix-vector operation is performed for a set of matrix elements corresponding to the actuatable elements (e.g., digitally actuatable phase shifters) in the plurality of optical circuits.

### BRIEF DESCRIPTION OF DRAWINGS

The components in the drawings are not necessarily to scale relative to each other. Like reference, numerals designate corresponding parts throughout the several views.

FIGS. 1A and 1B each shows an example recurrent quantum photonic processor that can generate squeezed photon states to prepare coherent photonic qubits that can be processed through recurrent linear-optic circuitries in accordance with an illustrative embodiment.

FIG. 2 shows a non-degenerate spontaneous four-wave mixing (SFWM) process and an example microring structure to execute the SFWM process that can be employed in an exemplary quantum optical processor.

FIG. 3 shows the method of operation of the example device in accordance with an illustrative embodiment.

FIG. 4 shows an example photonic circuit model of the recurrent quantum photonic processor in accordance with an illustrative embodiment.

FIG. 5 shows an example recurrent SVD photonic architecture and associated programming in accordance with an illustrative embodiment.

FIG. 6 shows an example fault tolerant MZI for the recurrent quantum photonic processor in accordance with an illustrative embodiment.

FIG. 7 shows an example baseline corrected system for the recurrent quantum photonic processor in accordance with an illustrative embodiment.

FIG. 8 shows another example quantum photonic processor can be processed through recurrent linear-optic circuitries in accordance with an illustrative embodiment. architecture.

FIGS. 9A-9E and 10 show simulation results for the quantum photonic processor. FIG. 9A shows the simulation results illustrating the advantage of the recurrent QPP architecture over conventional Mach-Zehnder interferometer (MZI) meshes. FIG. 9B shows the simulation results illustrating the advantage of the recurrent QPP architecture over conventional Mach-Zehnder interferometer (MZI) meshes against beamsplitter dispersion fabrication error (σ_{BS}). FIG. 9C shows the simulation results illustrating the advantage of the recurrent QPP architecture over conventional Mach-Zehnder interferometer (MZI) meshes against average beamsplitter error due to fabrication (μ_{BS}). FIG. 9D shows the simulation results illustrating the advantage of the recurrent QPP architecture over conventional Mach-Zehnder interferometer (MZI) for implementing Hadamard and Discrete Fourier Transform (DFT) matrices against σ_{BS}. FIG. 9E shows the simulation results illustrating the advantage of the recurrent QPP architecture over conventional Mach-Zehnder interferometer (MZI) for implementing Hadamard and DFT matrices against μ_{BS}.

FIG. 10 shows the learning curve of an optical neural network using the quantum photonic processor.

### DETAILED DESCRIPTION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entirety and to the same extent as if each reference was individually incorporated by reference.

### Example System #1

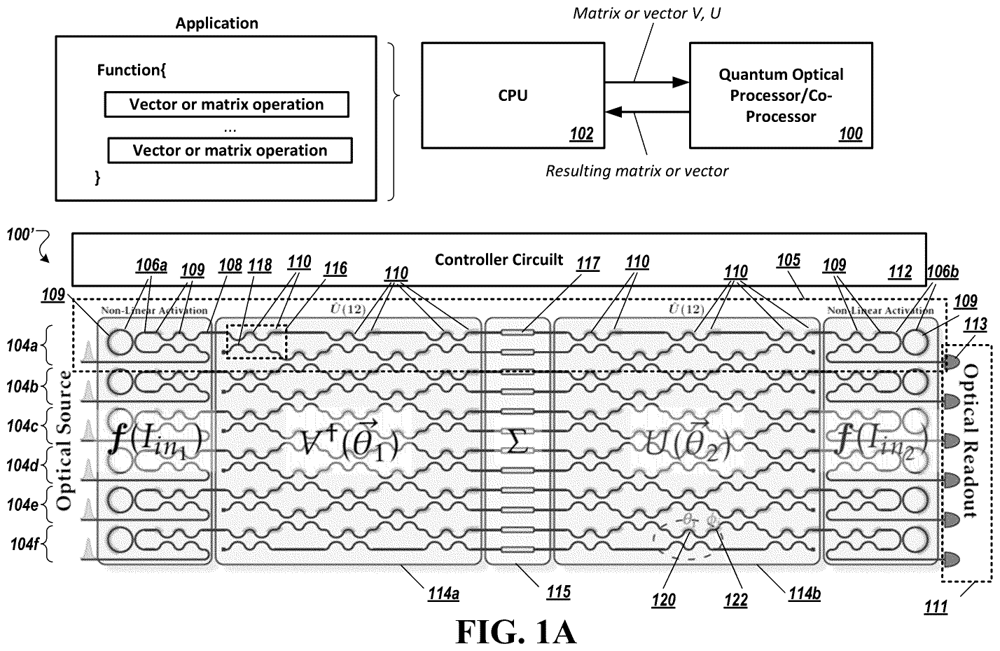

FIGS. 1A and 1B each shows an example recurrent quantum photonic processor 100 that can generate squeezed photon states to prepare coherent photonic qubits that can be processed through recurrent linear-optic circuitries in accordance with an illustrative embodiment. As used herein, the term “processor” refers to the central processor unit (CPU)), co-processor, processor core, graphic processor unit (GPU), processor module, or GPU module that are configured to execute program code or instructions encoded in tangible, computer-readable media.

In the example shown in FIG. 1A, the recurrent quantum photonic processor 100 (shown as “Quantum Optical Processor/Co-Processor” 100) operates with a CPU processor 102 (shown as “CPU” 102). The CPU 102 is configured to execute instructions for a computer software or application having vector operations (scalar-vector multiplication, dot product, cross product of vectors, etc.), e.g., in scientific or engineering simulations, modeling, or analysis, or graphic processing or modeling. The CPU 102 is configured to provide a set of matrices or vectors to the recurrent quantum photonic processor 100, along with a command to perform a matrix operation or matrix-associated operation. The command can denote the type of matrix operation. The recurrent quantum photonic processor 100 performs the operation and then returns the results to the CPU 102 to continue with the computer software or application. Of course, in some embodiments, the recurrent quantum photonic processor 100 may be a processing unit in a larger optical-based processor configured to execute a set of instructions.

More specifically, the recurrent quantum photonic processor 100 is a quantum photonic processor (QPP) processor with a depth of N optical interferometers. In the example shown in FIG. 1A, N optical interferometers each corresponding to N controllable element (e.g., as Mach-Zehnder interferometer (MZI)). An interferometer is an optical device which utilizes the effect of interference of photons. An input beam is provided into the optical circuit that is then separated by a beam splitter and modified by phase shifters to change the refractive properties of the waveguide transport. The beams are recombined by another set of beam splitters, and power of the beams are then measured as the output of the recurrent quantum photonic processor 100.

The recurrent quantum photonic processor 100 (shown as 100′) includes a plurality of optical circuits 104 (shown as 104a, 104b, 104c, 104d, 104e, 104f). The number of optical circuits 104 can be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64. In some embodiments, the number of optical circuits is greater than 64, e.g., between 64 and 128. In some embodiments, the number of optical circuits is greater than 128, e.g., between 128 and 256. In some embodiments, the number of optical circuits is greater than 256, e.g., between 256 and 512. In some embodiments, the number of optical circuits is greater than 512, e.g., between 512 and 1024.

The plurality of optical circuits 104 are arranged in the array corresponding to unitary matrices Û(12) 114a, 114b, e.g., for matrix-vector multiplier, shown as V^{†}(\vec{θ}₁) and U(\vec{θ}₂) in FIG. 1A. The matrix operation can be a vector matrix operation between V^{†}(\vec{θ}₁) and U(\vec{θ}₂). In FIG. 1A, the optical circuits 104 includes an array that forms a diagonal matrix 115 operation comprising an attenuator 117 (e.g., Mach-Zehnder interferometer) 117. One of the waveguides is not connected at the output so it can attenuate the light entering it. In some embodiments, the matrix operation can be scalar-vector multiplication, the dot product of vectors, or the cross product of vectors, among others.

FIG. 1B shows an example recurrent quantum photonic processor 100b comprising more than two unitary matrices 114 (shown as M₍₁₎ 114a, M₍₂₎ 114b, . . . , M₍ₙ₎ 114n).

An optical circuit 105 is highlighted, which shows each optical circuit 104 (e.g., 104a) includes a microring resonator 106 coupled to an optical source 108 (e.g., a laser, photodiode, or LED assembly), a waveguide 110 formed, for example, of silicon transport waveguide, and a set of one or more phase shifters 112 formed in the waveguide 110. The optical source 108 provides a pulse of light (e.g., a single photon or a temporal pulse of light), also referred to as a beam of photons to the optical circuit 104 having a distribution wavelength, e.g., Gaussian distribution. The phase shifters 112 of the optical circuits 104 are coupled to a controller circuit 112 that can adjust the resonance of the waveguides 110.

Microring resonators 106. The microring resonators 106 of the optical circuits 104 are coupled to an optical source 108 (e.g., laser coupled to a controllable splitter) and are tunable via digitally actuatable phase shifter 109 where a change in the phase by the digitally actuatable phase shifters 109 on each microring resonators 106 tune the wavelength resonance of the each microring resonator 106. The two sets of microring resonators 106 are shown as f(Iᵢₙ_{₁}) and f(Iᵢₙ_{₂}). At the other end of the waveguide 110 is an output 111 that can couple to a respective detector 113. In FIG. 1A, each optical circuit includes two microring resonators 106 (shown as 106a, 106b). Although one microring resonator 106a is directly coupled to the optical source, both microring resonators 106a, 106b allow for the tuning of the wavelength resonance as the recurrent nature of light transport in the waveguide entails light moving back and forth within the microring resonator. In some embodiments, a single set of microring resonators 106a are employed at the input, e.g., directly coupled to a laser source.

The microring resonators 106 may be configured to utilize spontaneous wave mixing (e.g., spontaneous four-wave mixing (SFWM)) to generate photon number states having a quantum uncertainty smaller than that of a coherent state for qubits (i.e., having squeezed photons states). In some embodiments, the microring resonators 106 are made of silicon nitride as silicon nitride microring resonators. The phase shifters 109 of the microring resonators 106 can be (i) heat-based as digitally actuatable heaters to adjust thermal properties of the microring resonators 106, (ii) optical-based as a digitally actuatable electro-optic element to adjust optical properties of the microring resonators 106, or (iii) electrical based as digitally actuatable silicon optical modulator to adjust electrical properties of the microring resonators 106.

Waveguide Phase Shifters 110. The set of phase shifters 110 in the waveguide 110 includes (i) a set of one or more tunable beamsplitters 116 formed by two waveguides, including waveguide 110 and an intermediate waveguide 118, and (ii) a set of one or more digitally actuatable phase shifters coupled to the waveguide 110. The intermediate waveguide 118 is optically coupled to its waveguide 110 (i.e., the waveguide of the same circuit, e.g., 104a) and a waveguide 110 of the next optical circuit (e.g., 104b). The adjustment by the phase shifters 110 imparts a phase shift in the optical circuit elements 104. In the example shown in FIG. 1A, each phase shifter 110 is digitally actuatable and includes a pair of actuatable elements to provide (i) an internal phase shifter θ (120) that can control, e.g., the amount of light rotated between both waveguides 110, 118 and (ii) the external phase shifter ϕ (122) that can control the global phase at the output of the optical interferometer (e.g., the Mach-Zehnder interferometer). The phase shifters 110 can be (i) heat-based as digitally actuatable heaters to adjust the thermal properties of the waveguides 110, 118, (ii) optical-based as a digitally actuatable electro-optic element to adjust optical properties of the waveguides 110, 118, or (iii) electrical based as digitally actuatable silicon optical modulator to adjust electrical properties of the waveguides 110, 118.

In the example shown in FIG. 1A, each optical circuit 104 includes three pairs of actuatable elements for each of the unitary tables 114a, 114b including three internal phase shifters θ₁, θ₂, and θ₃ and three external phase shifters ϕ₁, ϕ₂, and ϕ₃ as well as an internal phase shifter θ and an external phase shifters ϕ for each of the microring resonators 106a, 106b.

Controller Circuit 112. The controller circuit 112 is coupled to the set of one or more of digitally actuatable phase shifters of the first optical circuit and a second optical circuit. The controller circuit 112 receives inputs from a data bus to program the digitally actuatable elements 109, 110 for the optical circuits 104. For the 6 optical circuits with the 18 actuatable elements, the controller circuit 112 includes 108 digital outputs. The controller circuit 112 may employ demultiplexers and latches to generate the digital outputs from encoded values, e.g., 128-bit bus. The controller circuit 112 can be configured with other buses, e.g., 256-bit bus, 512-bit bus, 1024-bit bus, 2048-bit bus, etc.

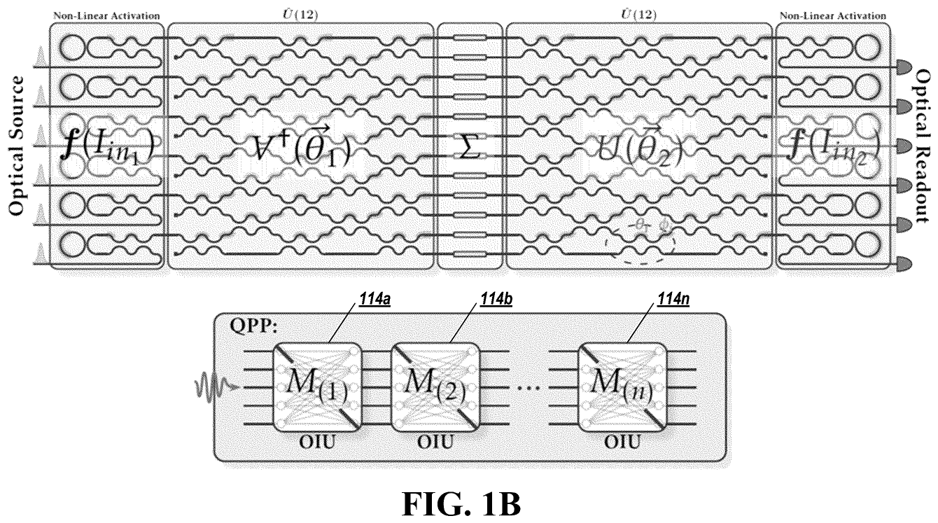

Generation and Detection of Squeezed Light by Microring Resonators. FIG. 2 shows a non-degenerate spontaneous four-wave mixing (SFWM) process and an example microring structure (e.g., of microring resonator 106) to execute the SFWM process that can be employed in an exemplary quantum optical processor to generate quadrature-squeezed states in the nanophotonic processor. The source of squeezed light allows optical sensitivity below the standard quantum limit (SQL) to be reached. The Hamiltonian describing the SFWM process can be expressed per Equation 1.

$${\hat{H}}_{SFWM} = {\sum }_{k}^{} ℏ {ω}_{k} {\hat{a}}_{k}^{†} {\hat{a}}_{k} + {ℏg𝒳}^{( 3 )} ( {\hat{a}}_{p}^{2} {\hat{a}}_{s}^{†} {\hat{a}}_{i}^{†} + {( {\hat{a}}_{p}^{†} )}^{2} {\hat{a}}_{s} {\hat{a}}_{i} ) \qquad ( Eq . 1 )$$

In Equation 1, the first expression ( [symbol] ℏωₖâₖ^{†}âₖ) can be referred to as Ĥₚₕₒₜₒₙ as the free Hamiltonian describing the photon field confined in the microring resonator. The later expression (ℏgχ⁽³⁾(âₚ²âₛ^{†}âᵢ^{†}+(âₚ^{†})²âₛâᵢ)) as the Hamiltonian Ĥᵢₙₜ describing the interaction part of SFWM. The index k iterates over the pump (p), signal (s), and idler (i) frequencies present, âₖ^{†} and âₖ are the photon creation and annihilation operators at frequency k, respectively, g is the coupling coefficient, and χ⁽³⁾ is the third-order susceptibility of the optical medium.

The physical actuation mechanism of the generation of the squeezed photon states may be through spontaneous four-wave mixing (SFWM) in silicon nitride microring resonators. SFWM process is an elastic process by which two pump photons (ωₚ) are annihilated, creating a pair of low-energy photons (ωᵢ) and (ωₛ), the idler and signal photons, respectively. Silicon nitride (Si₃N₄) is a readily available and mature material platform that can be used for integration by epitaxially grown-on silicon-on-insulator (SOI). Other materials can be used. In having the microring resonator 106 at each of the optical circuit 104, the source for quadrature-squeezed light can be provided at either end of the quantum photonic processor (QPP) architecture of FIG. 1A.

The exemplary system 100 can achieve a near-unity probabilistic emission of single-photon states in preparing photonic qubits. Principally, the device itself is straightforward: it serves to generate either amplitude or phase-squeezed photon states through the SFWM process. The SiN microring is then point coupled to a silicon transport waveguide, whereby a tunable phase shifter (e.g., 109) is overlaid above the waveguide ring 106 for tuning the wavelength resonance and stabilization. Silicon nitride microring can beneficially (i) provide low linear propagation loss (˜0.2 dB/cm); (ii) lack a nonlinear two-photon absorption (TPA) process; (3) possess a strong third-order χ⁽³⁾ nonlinear parameter (˜1 m⁻¹W⁻¹); (4) provide high compatibility with the commercial SOI process.

During the squeezing process, the generated photon states can introduce additional sinh²(η) photons on average, where n is the squeezing parameter (−1<η<1). To address the excess photons, a distributed Bragg grating (DBR) with a reflectivity of ˜72% may be employed. Then, an additional silicon microring can be point coupled to the exiting waveguide (e.g., 108) to spectrally filter out the ωᵢ photons prior to computation. The exemplary microring structure may be used in conjunction with FIG. 1A or other QPP devices.

Tunable Quantum Beamsplitter 116. The exemplary phase shifters (e.g., 110) can be configured to rely on the principle of changing the effective index of refraction by (i) acting on a single optical mode and (ii) imparting a unique phase to the input field per Equation 2.

$${\hat{a}}^{†} {⟹}^{PS} {e}^{i ϕ} {\hat{a}}^{†} \qquad ( Eq . 2 )$$

The phase shifter, denoted as “PS” in Equation 2, possesses no internal degrees of freedom, thus, there are no system Hamiltonian or coupling operators, so can be expressed as Equation 3.

$$SLH Triple : ( \begin{matrix}[ {e}^{i ϕ} ] & 0 & 0\end{matrix} ) \qquad ( Eq . 3 )$$

The beamsplitter (e.g., 116) with splitting ratio κ can be expressed as Equation Set 4.

$${\hat{a}}_{1}^{†} {⇒}^{BS} \sqrt{κ} {\hat{a}}_{1}^{†} + i \sqrt{1 - κ} {\hat{a}}_{2}^{†}$$

In Equation Set 4, θ represents the reflectivity of the beamsplitter. When θ=0, then there is perfect transmission, and when θ=π, then there is perfect reflectivity. κ=cos² θ. In addition to the above, other creation and annihilation photon operators for the phase shifter and beamsplitter transformations can be used, e.g., the beamsplitter (e.g., 116) can be replaced with an optical intensity I present within each optical mode/waveguide.

The free-carrier plasma dispersion effect can be leveraged to achieve modulation rates exceeding tens of gigahertz. However, intrinsic optical losses due to free-carrier absorption can result in substantial insertion losses of these devices described by the Kramers-Kronig relationship. The use of the free-carrier plasma dispersion effect for phase shifters in a large integrated photonic processor can be used if implemented with low insertion losses. The electro-optic effect can be utilized in the phase shifters as virtually lossless and can be made highly compact for dense integration on photonic-based systems.

In an example, a phase shifter (e.g., 120) can be sandwiched with two 50:50 beamsplitters (i.e., θ=π/2) that is then followed by an external phase shifter (e.g., 122). The exemplary tunable beamsplitter (e.g., 116) can then operate as a programmable linear optic Bogolioubov transformer per Equation 5.

$${\hat{U}}_{MZI} ( θ , ϕ ) := \frac{1}{2} [ \begin{matrix}1 & i \\ i & 1\end{matrix} ] [ \begin{matrix}{e}^{i ϕ} & 0 \\ 0 & 1\end{matrix} ] [ \begin{matrix}1 & i \\ i & 1\end{matrix} ] [ \begin{matrix}{e}^{i ϕ} & 0 \\ 0 & 1\end{matrix} ] = {ie}^{i \frac{θ}{2}} [ \begin{matrix}{e}^{i ϕ} sin ( \frac{θ}{2} ) & cos ( \frac{θ}{2} ) \\ {e}^{i ϕ} cos ( \frac{θ}{2} ) & - sin ( \frac{θ}{2} )\end{matrix} ] \qquad ( Eq . 5 )$$

In Equation 5, the internal phase shifter θ (e.g., 120) can control the amount of light rotated between both waveguides, and the external phase shifter ϕ (e.g., 122) can control the global phase at the output. Each tunable beamsplitter (e.g., 116), Mach-Zehnder interferometer (MZI), in the example shown in FIG. 2, is loaded with 6 electro-optic phase shifters.

### Example Programming of QPP and Matrix Decomposition

The quantum optical processor 100 can be programmed by controlling the phase shifters (e.g., 110) on each of the optical interferometers (e.g., Mach-Zehnder interferometers). The steps, in some embodiments, include decomposing a unitary matrix (e.g., U, V) into a set of Givens rotations. An arbitrary unitary matrix can be decomposed per Equation 6.

$$\hat{U} = D {\prod }_{ij} {\hat{T}}_{ij} ( θ , ϕ ) \qquad ( Eq . 6 )$$

In Equation 6, D is a diagonal matrix containing elements of e^{iϕ}, and \hat{T}ᵢⱼ(θ,ϕ) are the Givens rotations that null the i-th and j-th elements within the target unitary matrix Û. Each step in the process may correspond to nulling a target element within the target unitary matrix Û such that each step in the process builds up sequentially to Û. For each step in the nulling procedure, a set of phase shifts may be calculated by determining the splitting ratio needed to be implemented by the optical interferometers (e.g., Mach-Zehnder interferometers). The (complex) splitting ratio, s, may be calculated by taking the ratio of the transmissivity of the optical interferometer over its reflectivity such that

$$s = {e}^{i ϕ} tan ( \frac{θ}{2} ) .$$

Once the splitting ratio s is matched to a value of θ, then the value for ϕ may then be programmed into the optical interferometer. This then corresponds to the matrix as shown for Equation 5 for the MZI. The values for θ and ϕ may then be employed in Equation 5 for the MZI to compute the interferometer transformation.

The next step in the operation includes decomposing the MZI matrix through diagonalization Û_{MZI}=V·D·V^{\} where V corresponds to another unitary matrix, and D is a diagonal phase screen. The resulting unitary matrix may then be programmed into each of the MZIs on QPP by programming the transformation: Ŝ=VD^{1/2}V^{†}. Since D is a diagonal phase screen, it may correspond to the square root of the eigenvalues (phase shifts) corresponding to Û_{MZI}. Implementing the diagonalization and reconstruction of a square-root of Û_{MZI} may correspond to updating the splitting ratio per Equation 7.

$$\hat{S} ( θ ) = \frac{1}{\sqrt{2}} {e}^{i θ / 4} ( \begin{matrix}i + sin ( θ / 2 ) & cos ( θ / 2 ) \\ cos ( θ / 2 ) & i - sin ( θ / 2 )\end{matrix} ) \qquad ( Eq . 7 )$$

In Equation 7, a given value of θ can be determined as

$$s = - {ie}^{i \frac{ϕ}{2}} sec ( \frac{θ}{2} ) + {e}^{i ϕ} tan ( \frac{θ}{2} ) .$$

Mathematically, programming in the following unitary transformation for each of the MZIs in QPP can be expressed as Equation 8 such that Ŝ²=Û_{MZI}. An example execution of the algorithm is shown for an example 3×3 discrete Fourier transform matrix shown by Matrix 1.

$${\hat{U}}_{DFT} = \frac{1}{\sqrt{3}} [ \begin{matrix}1 & 1 & 1 \\ 1 & {e}^{- \frac{2 π}{3} i} & {e}^{- \frac{4 π}{3} i} \\ 1 & {e}^{- \frac{4 π}{3} i} & {e}^{- \frac{8 π}{3} i}\end{matrix} ] = [ \begin{matrix}0.394 & - 0.289 + 0.289 i & 0.211 + 0.789 i \\ - 0.183 + 0.683 i & 0.5 + 0.5 i & 0 \\ 0.577 & - 0.289 + 0.5 i & - 0.289 - 0.5 i\end{matrix} ] \qquad ( Matrix 1 )$$

The discrete Fourier transform matrix is unitary and has a dimension of 3. The first Givens rotation right can multiply the target unitary of Matrix 1 above such that it nulls one element within the unitary matrix as follows:

In order to null this element, the splitting ratio s that is required to null this element within the unitary is used to calculate the value of θ and ϕ where they are calculated to be 1.571rad and −1.047rad, respectively. These values are then updated to implement the matrix Ŝ such that θ is updated to be 2.253rad. The next step involves nulling at least one extra element within the target matrix, shown as Matrix 2.

$$[ \begin{matrix}- 0.577 & 0 & 0.211 + 0.789 i \\ 0 & 0 & 0 \\ 0.789 - 0.211 i & 0 & - 0.289 - 0.5 i\end{matrix} ] \qquad ( Matrix 2 )$$

Repeating the procedure above, a splitting ratio s may be determined, which may then be mapped to a specific value of θ and ϕ (i.e., 1.571rad and 1.047rad, respectively, for this example). The internal phase shifter value, θ, may then be updated in accordance to implement the unitary matrix Ŝ such that θ is updated to 1.800rad. The next step involved in decomposing the unitary matrix involves nulling all of the off-diagonal elements in the unitary matrix which results in Matrix 3.

$$[ \begin{matrix}0.577 + 0.816 i & 0 & 0 \\ 0 & - 1 & 0 \\ 0 & 0 & - 0.769 - 0.639 i\end{matrix} ] \qquad ( Matrix 3 )$$

In Matrix 3, the value of θ and ϕ may be found to be 1.231rad and −1.833rad, and the value of θ is then 2.145rad. The resulting matrix above corresponding to the diagonal phase screen D, where it contains elements of e^{iϕ}. This diagonal phase screen may be programmed into QPP by taking the arguments of each of the elements and programming those values into the phase shifters, respectively. Hence, this operation takes a target unitary matrix and decomposes it into a set of square-root Givens rotations with modified phase shift angles to reconstruct the unitary matrix optically. To generalize the computations performed (e.g., matrix-vector multiplication), QPP can also take advantage of singular value sdecomposition (SVD).

Whispering-gallery-mode resonators. In addition to traditional microring resonator structures, whispering-gallery-mode resonators may be used. Whispering-gallery-mode resonators, when used, can permit a higher quality factor (Q-factor) while maintaining a minimum bend radius. The Q-factor of a microring resonator describes the round-trip cavity loss that light experiences within the resonator (higher values permit longer photon lifetimes). Improvements in the Q-factor (photon lifetime) of each SFWM optical source thereby decrease the signal-to-noise ratio (SNR) and permit the use of a weaker optical pump. Interestingly, with the exemplary microring design with whispering gallery mode resonators, the field enhancement factor, E, may be directly proportional to the photon generation rate at E∝Q³/R². The field enhancement factor can then correlate to the generation rate of bright-pair photons during the squeezing process.

To illustrate compatibility with the programmable linear-optic logic on QPP, the study that was conducted (later described herein) employed light-pair photons generated on the order of ˜10⁵ counts/sec, which is within the same order of magnitude as that of the full number of reconfigurations that can be achieved on QPP. Each SiN single photon emitter corresponds to the preparation of a coherent photonic qubit. In this case, a total of 30 SiN microrings may provide full operability for the 15 photonic qubits. In this achievable domain, all photons are anti-bunched (i.e., spaced with even time intervals).

In contrast to many other works that utilize spontaneous parametric down-conversion as a means to generate single photons, SFWM is not a probabilistic-dependent optical process. Thus, SFWM here can remain reliable when employed as an on-demand optical generation source for the quantum photonic processor. With the exemplary method, quantum photonic processors can effectively decrease the SNR of the single-photon detectors and optical sensitivity below the SQL.

Detector 113. The optical circuit 104 each further includes a detector 113 that can include the second microring resonator 106b (e.g., also configured for spontaneous four-wave mixing (SFWM)). Detection of the quadrature-squeezed states can be implemented through a balanced homodyne detection scheme using a balanced 50:50 beamsplitter (e.g., 116) where two photodiodes are loaded on each waveguide arm. Once both photodiodes detect the squeezed state, the current generated is equivalent to the difference in the photocurrents produced in the waveguide arm. The exemplary detection operation can remove classical noise effectively from the photodiodes and reach sub-classical noise in photodetection.

Discussion. In mathematics and vector algebra, the cross product or vector product is a binary operation on two vectors in three-dimensional vector space. For two linearly independent vectors, the cross product is a vector that is perpendicular to both vectors and thus normal to the plane containing them. Vector cross product can be expressed and calculated as the product of a skew-symmetric matrix and a vector.

The dot product or scalar product is an algebraic operation that takes two equal-length sequences of numbers, e.g., in the form of coordinate vectors, and returns a single number. The dot product of the Cartesian coordinates of two vectors is widely used and is often referred to as the inner product of Euclidean space. In many computing applications, cross-products, dot products, and other vector or matrix operations are performed using 32 bits or 64 bits of data.

The use of cross product, dot-product, and matrix multiplication are used in many computing applications for analysis or controls. Vector and matrix operations are also heavily utilized in machine learning and AI algorithms. The exemplary processor (e.g., 100) can exponentially reduce the computational complexity of performing matrix operations, e.g., employing the exponentially large Hilbert spaces that are generated through light-speed tensor computations.

### Example Method of Operation

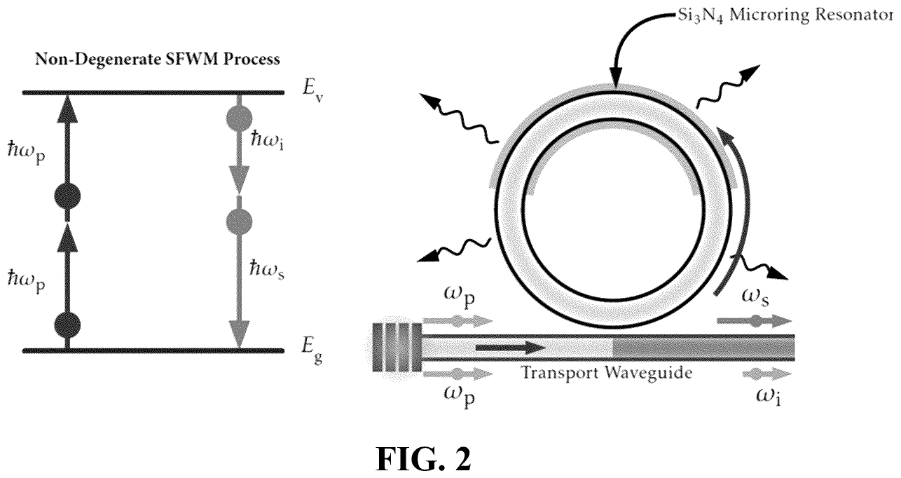

FIG. 3 shows the method of operation of the example device. During QPP programming, the phase actuators (e.g., 110) (e.g., microheaters, electro-optics, etc.) may be clustered into three distinct groups and permute in operation and activation during each recursion cycle on QPP. By the appropriate programming and permitting of the phase shifter groups, any unitary matrix of dimension 2, U(2), up to a global phase of 2π, can be selected. Intuitively, QPP can employ the use of electro-optic phase shifters by alternating the order and use of each of the phase shifters to minimize down-time.

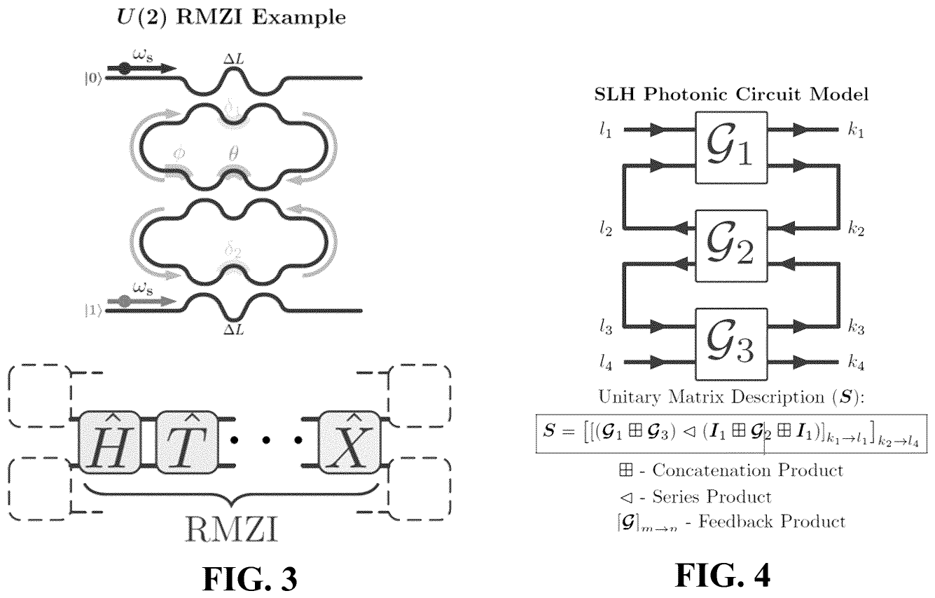

Photonic Circuit Model. FIG. 4 shows an example photonic circuit model. In FIG. 4, an (even) dimensional layer within the recurrent QPP (e.g., 100) can be described by the unitary (Sₑᵥₑₙ) per Equation 8.

$${S}_{even} = {I}_{1} {\hat{T}}_{{MZI}_{11}} {\hat{T}}_{{MZI}_{21}} {\hat{T}}_{{MZI}_{31}} … {\hat{T}}_{{MZI}_{N 1}} {I}_{1} \qquad ( Eq . 8 )$$

An (odd) dimensional layer within recurrent QPP may be described by the unitary (S_{odd}) per Equation 9.

$${S}_{odd} = {\hat{T}}_{{MZI}_{12}} {\hat{T}}_{{MZI}_{22}} {\hat{T}}_{{MZI}_{32}} {\hat{T}}_{{MZI}_{N 2}} \qquad ( Eq . 9 )$$

Then, the full description of recurrent QPP can be obtained per Equation 10.

$${S}_{QPP} = {△}_{j = 1}^{R} {△}_{i = 1}^{D} {S}_{{even}_{ij}} ⊲ {S}_{{odd}_{ij}} = D {\prod }_{( i , j ) ∈ S} {\hat{T}}_{ij} ( θ , ϕ ) \qquad ( Eq . 10 )$$

Programming each of the electro-optic phase shifters may be implemented using a digital-to-analog converter (DAC), e.g., of the controller circuit 112. Each DAC may program an appropriate voltage from a calculated phase shift on a digital computer, which corresponds to a phase shift on a waveguide.

### Example Linear Optic State Evolution and Programming QPP

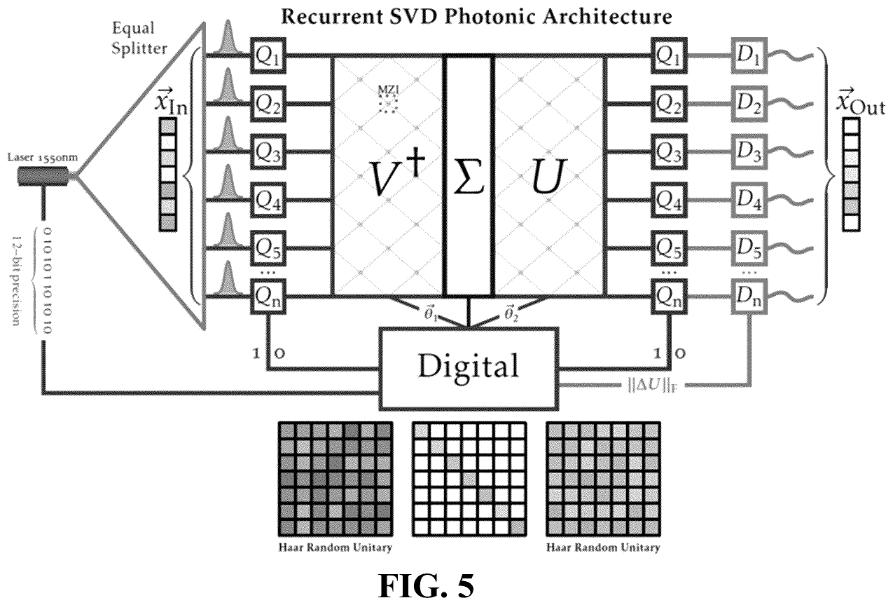

FIG. 5 shows an example recurrent SVD photonic architecture to which QPP programming may be performed. In FIG. 5, a discrete unitary operator is employed in the QPP by programming a set of phase shifts that program the MZI mesh with a series of steps (complex-valued rotations). Each step built up to the target matrix such that for every complex valued rotation, a set of phase shifts for each MZI was then calculated precisely to null a specific matrix element in the target matrix. Once each nulling step is precisely completed, the QPP can perfectly realize the target matrix.

In an operation, the exemplary QPP (e.g., 100) may perform unitary transformations (complex-valued rotations), which can form the basis of quantum computing formalisms. The set of basis states are called Fock states. Due to the high indistinguishability between each input photon, there can exist a multitude of combinations that these photons can take at the input for photonic-qubit preparation. These can be useful for determining the transition amplitudes after unitary evolution in QPP (i.e., quantum computations) and further highlight that all Focks states are valid for the computational basis. With the 15-qubit QPP, there can be a total of 2.3×10¹¹ Focks states, which are invalid and do not serve as the computational basis. This computational scheme is known as post-selection and can be employed as the encoding scheme for photonic qubits. For classical information processing (e.g., arbitrary matrix-vector product computations), QPP can utilize Singular Value Decomposition (SVD). In SVD, both unitary matrices can be implemented as a mesh of MZIs, and the diagonal matrix in SVD can be implemented through a layer of MZIs with one waveguide path that is dead, thus allowing attenuation of the light. Since the diagonal matrix in SVD contains non-negative elements, the diagonal matrix is normalized relative to the largest singular present within the matrix. As a result, this allows the use of a single layer of MZIs to implement the diagonal matrix in classical information processing.

Experimental Results and Additional Examples. A study was conducted to develop and evaluate a recurrent quantum photonic processor. A prototype was fabricated and evaluated.

Prototype Benchmarking. Benchmarking the QPP fabricated in the study involved programming 10,000 random unitary matrices (complex-valued rotations) from the Haar measure. The Haar measure samples uniformly from the space of all unitary matrices U(N) of dimension N. Sampling a Haar random unitary was done by sampling from a uniform distribution in direct propagation to the volume of the region defined by the Haar measure. The approach taken to generate a Haar random unitary is as follows: it begins by generating a Gaussian matrix (Ginibre ensemble) and then orthogonalizing it via the Gram-Schmidt process. Then, phase shifts can be calculated and programmed into each MZI, effectively programming the QPP to implement the matrix. From here, the experimentally U_{Experimental} realized and ideal U_{Ideal} transformation can be compared to measure the fidelity (closeness) of the computation. Ordinarily, the Frobenius (L2) norm serves as the mathematical metric to measure the distinctness between linear-optic transformations. However, without intimate knowledge of the error that has manifested from fabrication, it is imperative to rapidly diagnose these errors and rectify them.

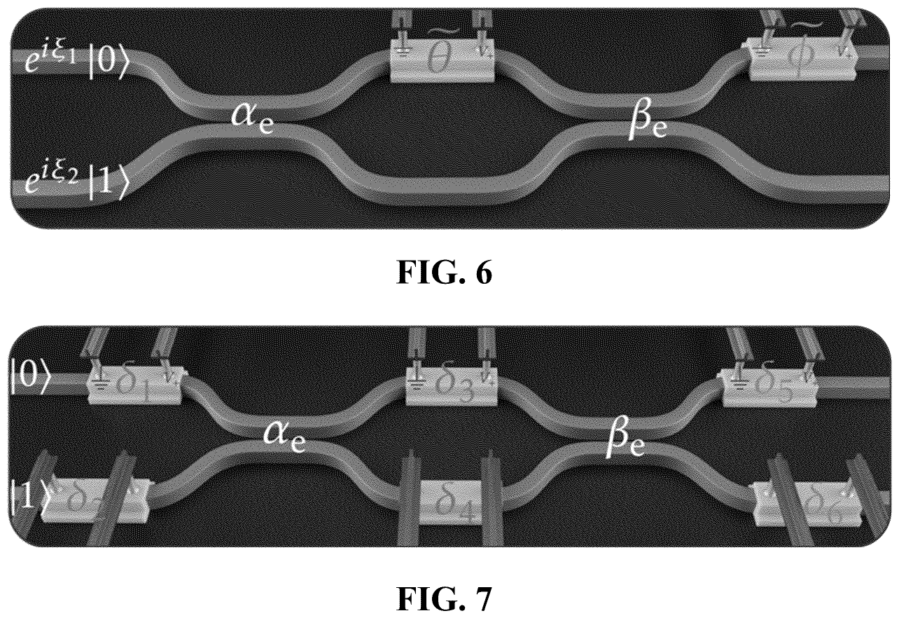

QPP Hardware Error Correction: FIG. 6 shows an example fault tolerant MZI. The approach can be employed for each MZI individually. Initially, well-informed assumptions are first made about the system, in that the quantum photonic processor exhibits ideal behavior (i.e., all MZIs can realize extremum states: bar- and cross-states).

Each MZI can then be investigated by the selection of a target MZI and programming it to perform cross-state and programming all other MZIs to perform the bar-state. By observing the fidelity of the operation, matrix error can then be minimized by randomly changing the phase shifts within the target MZI (δ₁, δ₂, δ₃, δ₄, δ₅, δ₆) until maximum fidelity is achieved: ≥99.99%. Then, the unbalanced beamsplitter coefficients and optical loss can be calculated for the MZI per Equation 11.

$${\hat{T}}_{MZI} = ⌈ \begin{matrix}cos ( \frac{π}{4} + {a}_{e} ) & i sin ( \frac{π}{4} + {a}_{e} ) \\ i sin ( \frac{π}{4} + {a}_{e} ) & cos ( \frac{π}{4} + {a}_{e} )\end{matrix} ⌉ ⌈ \begin{matrix}{γ}_{1} {e}^{\tilde{i θ}} & 0 \\ 0 & {γ}_{2}\end{matrix} ⌉ ⌈ \begin{matrix}cos ( \frac{π}{4} + {β}_{e} ) & i sin ( \frac{π}{4} + {β}_{3} ) \\ i sin ( \frac{π}{4} + {β}_{3} ) & cos ( \frac{π}{4} + {β}_{e} )\end{matrix} ⌉ ⌈ \begin{matrix}{γ}_{3} {e}^{\tilde{i θ}} & 0 \\ 0 & {γ}_{4}\end{matrix} ⌉ ⌈ \begin{matrix}csc ( π / 2 + {δ}_{1} ) & 0 \\ 0 & csc ( π / 2 + {δ}_{2} )\end{matrix} ⌉ \qquad ( Eq . 11 )$$

In Equation 11, αₑ and βₑ are unbalanced beamsplitter coefficients, and γⱼ=\sqrt{1−εⱼ}, where εⱼ∈[0,1]∀ⱼ represents the percent optical loss contributed by each optical waveguide. The values of δ₁ and δ₂ represent the optical amplification of the input vector as a function of phase.

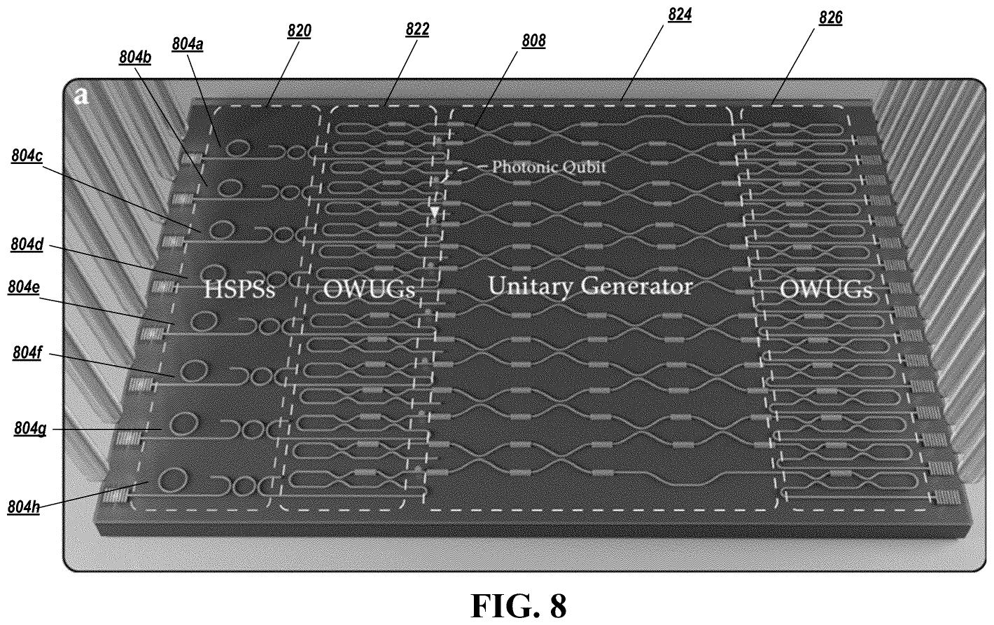

FIG. 7 shows an example baseline corrected system. In FIG. 7, this process was repeated throughout the MZI mesh until each MZI was calibrated. The procedure can allow for a straightforward algorithm to empirically determine new static phase shifts to increase the fidelity of the operation programmed on-chip and the visibility of each interferometer for quantum computation. Although, in principle, the error-correction scheme can resolve hardware errors to perfect fidelity, not all quantum computations are realizable.

Hardware error correction was further extended in the instant study using the Riemann sphere. In particular, the Riemann sphere allow the extension of the current analysis of static-hardware errors to the long-term benefit and error-capability in adding redundant photonic quantum gates. For instance, an ideal MZI may access the full Riemann sphere, whereas a realistic MZI on QPP may only access a subspace of the Riemann sphere during quantum computations. When decomposing a target unitary matrix into 2×2 Givens rotations by the MZI mesh, the extinction ratios (ERs) that are required during programming was plotted on the Riemann sphere. In other words, all calculated phase shifts for each MZI correspond to an ER from one to infinity, which were plotted on the Riemann sphere. As a result, a layer of Pauli-X rotation gates was programmed, which effectively corresponds to a rotation of the Riemann sphere from the poles to the equators. The equators are regions where quantum computations are perfectly realizable through the error correction scheme. The layer of redundant Pauli-X rotations in the Bloch sphere corresponds equivalently to performing a rotation on the Riemann sphere; transforming an imperfect QPP to become perfect when programming deep quantum circuits.

### Example Recurrent Quantum Photonic Processor System #2

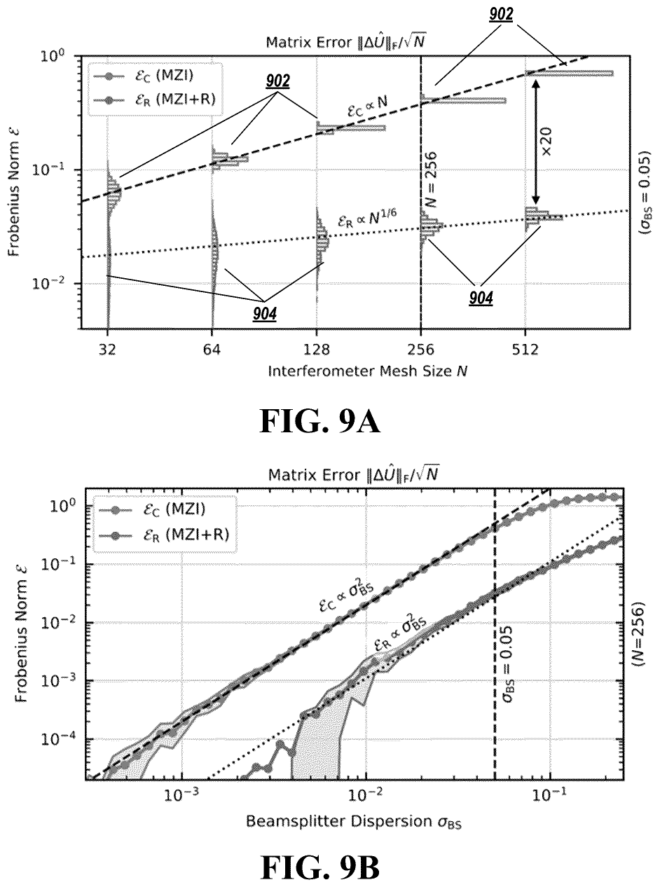

FIG. 8 shows another example quantum photonic processor 100 (referred to as recurrent quantum photonic processor 800) with a different QPP architecture. The recurrent quantum photonic processor 800 also includes a plurality of optical circuits 104 (now referred to as optical circuits 804) in which each optical circuit 104 includes a microring resonator 106 (e.g., silicon nitride microring resonators) that utilizes spontaneous wave mixing (e.g., spontaneous four-wave mixing (SFWM)) to generate photon number states having a quantum uncertainty smaller than that of a coherent state for qubits (i.e., having squeezed photons states).

The optical circuit 804 also includes a waveguide 108 (e.g., silicon transport waveguide) (now referred to as waveguide 808) point coupled to the microring resonator 804 in which the waveguide 808 includes a set of phase shifters 110 (now referred to as phase shifters 810) each comprising (i) a set of one or more tunable beamsplitters formed in part of waveguide and (ii) a set of one or more digitally actuatable phase shifters coupled to a portion the waveguide.

The quantum photonic processor 800 includes a controller circuit (e.g., 112) that couples to the set of digitally actuatable phase shifters 810 of the optical circuit 804. In the example shown in FIG. 8, voltage adjustment by the digitally actuatable phase shifters can cause a phase shift in the respective optical circuit 804.

In FIG. 8, the quantum photonic processor (QPP) is capable of encoding, manipulating, and propagating quantum information in the form of photons. The photonic qubits are encoded by the presence of a photon within two adjacent nanowires that guide light. When the photon is in the upper nanowire (waveguide), the photon encodes the |0> state of the qubit, and conversely, when the photon is in the lower path, the photon encodes the |1> state.

The single photons may be generated within the heralded single-photon sources (HSPS) region 820. Then, the single photons are led upstream toward the light-speed tensor core of the quantum photonic processor where quantum computations take place. The photons in FIG. 8 are led into the one-way unitary gates (OWUGs) layer 822. The OWUG layer 822 serves to either: (i) direct the photons toward the single-photon detectors for optical readout; and (ii) shoot the photons back into QPP for further quantum computations. The unitary generator layer 824 is positioned in between two OWUG layers, the first OWUG layer 822, and a second OWUG layer 826, the two layers 822 and 826, allowing for linear optic quantum recursion to take place.

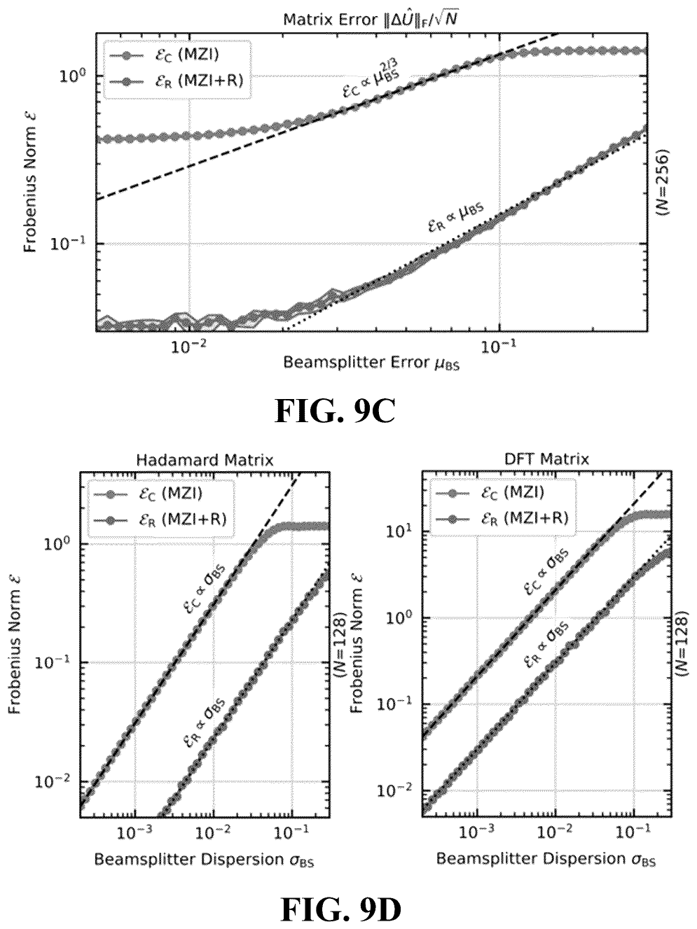

Experimental Results and Additional Examples. FIGS. 9A-9E show simulation results for the quantum photonic processor 800. Specifically, FIG. 9A shows the simulation results illustrating the advantage of the recurrent QPP architecture over conventional Mach-Zehnder interferometer (MZI) meshes. FIG. 9B shows the simulation results illustrating the advantage of the recurrent QPP architecture over conventional Mach-Zehnder interferometer (MZI) meshes against beamsplitter dispersion fabrication error (σ_{BS}). FIG. 9C shows the simulation results illustrating the advantage of the recurrent QPP architecture over conventional Mach-Zehnder interferometer (MZI) meshes against average beamsplitter error due to fabrication (μ_{BS}). FIG. 9D shows the simulation results illustrating the advantage of the recurrent QPP architecture over conventional Mach-Zehnder interferometer (MZI) for implementing Hadamard and Discrete Fourier Transform (DFT) matrices against σ_{BS}. FIG. 9E shows the simulation results illustrating the advantage of the recurrent QPP architecture over conventional Mach-Zehnder interferometer (MZI) for implementing Hadamard and DFT matrices against μ_{BS}.

With the in-silico modeling, the recurrent QPP processor 800 was simulated from 32≤N≤512, where N is the size of the MZI mesh and was compared to a conventional MZI architecture. The y-axis plots (in FIGS. 9A-9E) the normalized Frobenius norm (matrix-error). The Frobenius norm is a mathematical metric that allows one to determine the distinctness between two (unitary) matrices. A larger Frobenius norm matrix error indicates a decrease in the fidelity of the quantum computation performed.

The Frobenius norm ∥ΔÛ∥_{F} as a measure of the distinctness between two unitary operators and the average error per matrix element can be given as Equation 12.

$$〈 {ε}_{err}^{( N )} 〉 = 〈 {‖ {\hat{U}}_{MZI} ( θ , ϕ ) - {\hat{T}}_{MZI} ( \tilde{θ} , \tilde{ϕ} , {a}_{e} , {β}_{e} , {δ}_{1} , {δ}_{2} , γ ) ‖}_{F} 〉 = \frac{1}{\sqrt{N}} \sqrt{{\sum }_{i = 1}^{N} {\sum }_{j = 1}^{N} 〈 {\vert {\hat{u}}_{ij} - {\hat{t}}_{ij} \vert}^{2} 〉} \qquad ( Eq . 12 )$$

In Equation 12, the minimum error can be achieved for an arbitrary choice of θ and ϕ per Equation 13 in which θ∈[0,2π] and ϕ∈[0,2π].

$$\frac{\partial {ε}_{err}^{( N )}}{\partial θ} = \frac{\partial {ε}_{err}^{( N )}}{\partial ϕ} = 0 \qquad ( Eq . 13 )$$

In FIG. 9A, the histograms 902 represent a conventional MZI layout, whereas the architecture 902 displays the truncated MZI architecture with optical recursion enabled. From the plots, it can be observed that there is an order of magnitude reduction in the (Frobenius) matrix error with the MZI and recursion (MZI+R) scheme in the photonic domain. Additionally, the architecture benefits from a smaller physical footprint while achieving greater fidelity in operation. Convention MZI architectures require a depth of N MZIs for an N-dimensional transformation. The processor 800, on the other hand, has a depth of two MZIs for any dimension N.

The processor 800 (as well processor 100) can be used to train optical neural networks (ONNs), e.g., through arbitrary matrix-vector products performed in the optical domain. An arbitrary matrix can be programmed into processor 800 by first decomposing the target matrix using singular value decomposition (SVD) where each decomposed matrix is then individually implemented on QPP. In a demonstration, the instant study performed training an ONN was performed on the Modified National Institute of Standards and Technology (MNIST) hand-digit classification dataset containing 60,000 handwritten digits of 28×28 pixels. The processor 800 computed a 2D Fourier transform of the images and then performed a \sqrt{N}×\sqrt{N} crop of the MNIST images, where N=64. Specifically, the 2D Fourier transform mathematically was defined as c(kₓ, k_{y})=Σ_{m,n}g(m, n)e^{i(k}^{ₓ}^{m+k}^{_{y}}ⁿ⁾, where g(m, n) was the normalized grayscale value of the pixel at the location (m, n) within the image. The coefficients c(kₓ, k_{y}) were generally complex-valued moments with wavenumbers in both the x- and y-directions of the image.

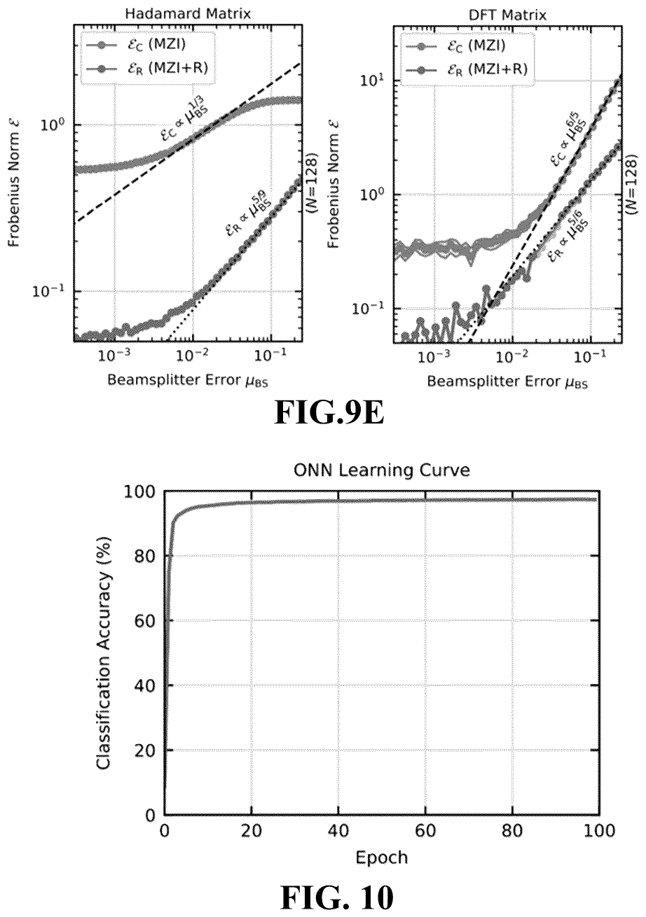

FIG. 10 shows the learning curve of an ONN with 32 neurons and two hidden layers trained on the MNIST dataset.

### Discussion

Example Computing Device. The processor (e.g., 100, 800) can be employed in a computing device 400 that can include, but not limited to, personal computers, servers, handheld or laptop devices, multiprocessor systems, microprocessor-based systems, network, personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

The computing device may include the processing unit (e.g., 102) and system memory. Depending on the exact configuration and type of computing device, system memory may be volatile (such as random-access memory (RAM)), non-volatile (such as read-only memory (ROM), flash memory, etc.), or some combination of the two. The processing unit may perform arithmetic and logic operations necessary for the operation of the computing device. The computing device may also include a bus or other communication mechanism (e.g., digital bus or optical bus) for communicating information among various components of the computing device.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example of tangible, computer-readable media may include, but is not limited to, volatile media, non-volatile media, removable media, and non-removable media implemented in any method or technology for storage of information such as computer-readable instructions, data structures, program modules or other data. System memory, removable storage, and non-removable storage are all examples of tangible computer storage media. Examples of tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory. For example, the bus may carry data to the system memory, from which the processing unit receives and executes instructions. The data received by the system memory may optionally be stored on the removable storage or the non-removable storage before or after execution by the processing unit.

One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

### CONCLUSION

Each and every feature described herein, and each and every combination of two or more of such features, is included within the scope of the present invention, provided that the features included in such a combination are not mutually inconsistent.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

While the methods and systems have been described in connection with certain embodiments and specific examples, it is not intended that the scope be limited to the particular embodiments set forth, as the embodiments herein are intended in all respects to be illustrative rather than restrictive.

The following patents, applications, and publications, as listed below and throughout this document, are hereby incorporated by reference in their entirety herein.

### REFERENCES

What we claim is:

1. A quantum photonic processor comprising:
a plurality of optical circuits, including a first optical circuit and a second optical circuit, wherein the first optical circuit and the second optical circuit each includes:
a first microring resonator that utilizes spontaneous optical wave mixing processes to generate squeezed single photon number states having a quantum uncertainty smaller than that of a coherent state for qubits and to generate single photon Fock states;
a waveguide point coupled to the first microring resonator;
a set of one or more phase shifters each comprising (i) a set of one or more tunable beamsplitters formed in part of waveguide and (ii) a set of one or more digitally actuatable elements coupled to a portion the waveguide; and
a controller circuit coupled to the set of one or more of digitally actuatable elements of the first optical circuit and a second optical circuit, wherein adjustment by the one or more digitally actuatable elements by the controller circuit cause a phase shift in the respective first optical circuit and a second optical circuit to correspond to a matrix operation to be performed by the plurality of optical circuits.

2. The quantum photonic processor of claim 1, wherein the plurality of optical circuits are arranged in an array of recurrent first optical circuit and second optical circuit, wherein the array corresponds to a matrix vector multiplication operation.

3. The quantum photonic processor of claim 1, wherein the first microring resonator of the first optical circuit and a second optical circuit are configured to exhibit spontaneous four-wave mixing (SFWM).

4. The quantum photonic processor of claim 1, wherein each microring resonator of the first optical circuit and a second optical circuit is tunable, the each microring resonator includes at least one digitally actuatable heater, wherein thermal adjustment by the one or more digitally actuatable heaters of the each microring resonator tune the wavelength resonance of the each microring resonator.

5. The quantum photonic processor of claim 1, wherein the controller circuit receives inputs from a data bus to program the one or more digitally actuatable elements.

6. The quantum photonic processor of claim 1, wherein each microring resonator of the first optical circuit and a second optical circuit is tunable, the each microring resonator includes at least one digitally actuatable phase shifter, wherein adjustment by the one or more digitally actuatable phase shifter element of the each microring resonator tune the wavelength resonance of the each microring resonator.

7. The quantum photonic processor of claim 1, wherein each microring resonator of the first optical circuit and a second optical circuit is tunable, the each microring resonator includes at least one digitally actuatable electro-optic element, wherein adjustment by the one or more digitally actuatable electro-optic of the each microring resonator tune the wavelength resonance of the each microring resonator.

8. The quantum photonic processor of claim 1, wherein each microring resonator of the first optical circuit and a second optical circuit is tunable, the each microring resonator includes at least one digitally actuatable silicon optical modulator, wherein adjustment by the one or more digitally actuatable silicon optical modulator of the each microring resonator tune the wavelength resonance of the each microring resonator.

9. The quantum photonic processor of claim 1, wherein each microring resonator of the first optical circuit and second optical circuit is coupled to an optical source, and
wherein the optical source is coupled to the controller circuit configured to amplitude modulate or frequency modulate the optical source.

10. The quantum photonic processor of claim 1 further comprising:
a mesh of photonic interferometers each comprising of (i) a set of tunable phase shifters and (ii) integrated optical 50:50 beamsplitters formed by waveguides that are capable of selecting any unitary matrix of dimension 2;
a truncated mesh of photonic MZIs that are in between two layers of MZIs that are linked back to themselves that enable optical recursion to build MZIs in series for performing matrix-vector multiplication and for factorizing unitary matrices; and
a balanced set of single photon detectors for optical readout of the single photon states to provide a reduction and removal of classical noise during single photon detector.

11. The quantum photonic processor of claim 1, wherein the first optical circuit and second optical circuit each further includes:
a detector comprising a second microring resonator.

12. The quantum photonic processor of claim 1, wherein each first microring resonator of the first optical circuit and second optical circuit is formed on an insulator to form a silicon-on-insulator structure.

13. The quantum photonic processor of claim 1, wherein the first microring resonator of the first optical circuit and second optical circuit is a silicon nitride microring resonator.

14. The quantum photonic processor of claim 1, wherein each first microring resonator of the first optical circuit and second optical circuit includes spectrally selective photonic component.

15. The quantum photonic processor of claim 1, wherein each first microring resonator of the first optical circuit and second optical circuit is configured as a whispering-gallery-mode resonator.

16. The quantum photonic processor of claim 1, wherein each set of one or more tunable beamsplitters of the first optical circuit and second optical circuit is a Mach-Zehnder interferometer (MZI) comprising a plurality of phase shifters.

17. The quantum photonic processor of claim 1, wherein the detector comprises a balanced homodyne detector.

18. The quantum photonic processor of claim 1 further comprising:
a second plurality of optical circuits having the first optical circuit and the second optical circuit, wherein the second plurality of optical circuits is configured to perform a second matrix-vector operator.

19. The quantum photonic processor of claim 1 further comprising: a detector coupled to the waveguide; and
an analog-to-digital converter coupled to the detector, the analog-to-digital converter provide output to a processor, wherein the output correspond to a matrix operation performed by the plurality of optical circuits.

20. The quantum photonic processor of claim 1, wherein the quantum photonic processor is configured as a co-processor for a microprocessor, a quantum processor, or an optical processor.
